(19) United States
(12) Patent Application Publication
(10) Pub. No.: US 2024/0318028 A1
(43) Pub. Date: Sep. 26, 2024

(54) ANTI-FROST HYDROGEL COATING COMPOSITION, METHOD FOR MANUFACTURING HYDROGEL COATING FILM USING THE SAME, AND HEAT EXCHANGER INCLUDING THE SAME

(71) Applicants: SAMSUNG ELECTRONICS CO., LTD., Suwon-si (KR); KOREA UNIVERSITY RESEARCH AND BUSINESS FOUNDATION, Seoul (KR)

(72) Inventors: Kihun JEONG, Suwon-si (KR); Youngdeog KOH, Suwon-si (KR); Yongchan KIM, Seoul (KR); Kookjeong SEO, Suwon-si (KR); Jihun SEO, Seoul (KR); Jungsoo LIM, Suwon-si (KR); Changho HAN, Pyeongtaek-si (KR); Daewon KIM, Seoul (KR); Jeongwoo ROH, Seoul (KR); Eunji LEE, Seoul (KR); Joonbum LEE, Seoul (KR)

(73) Assignees: SAMSUNG ELECTRONICS CO., LTD., Suwon-si (KR); KOREA UNIVERSITY RESEARCH AND BUSINESS FOUNDATION, Seoul (KR)

(21) Appl. No.: 18/436,782

(22) Filed: Feb. 8, 2024

Related U.S. Application Data
(63) Continuation of application No. PCT/KR2024/001338, filed on Jan. 29, 2024.

(30) Foreign Application Priority Data
Mar. 24, 2023 (KR) 10-2023-0038921

(51) Int. Cl. C09D 133/14; C09D 5/00; C09D 7/61; C09D 7/63; C09D 133/08; C09D 143/02

(52) U.S. Cl. CPC C09D 133/14; C09D 5/00; C09D 7/61; C09D 7/63; C09D 133/08; C09D 143/02

(57) ABSTRACT

Disclosed are an anti-frost hydrogel coating composition including an ionic monomer, a method of forming an anti-frost hydrogel coating film on a substrate, and a heat exchanger including the anti-frost hydrogel coating film, the anti-frost hydrogel coating composition can include: an ionic monomer; a crosslinker including two or more acrylic groups; a polymerization initiator; and a solvent, and the ionic monomer can include at least one ionic monomer from among a zwitterionic monomer, a cationic monomer, and an anionic monomer.

### CROSS-REFERENCE TO RELATED APPLICATIONS

This is a continuation application of International Application No. PCT/KR2024/001338, filed Jan. 29, 2024, which is incorporated herein by reference in its entirety, it being further noted that foreign priority benefit is based upon Korean Patent Application No. 10-2023-0038921, filed Mar. 24, 2023, which is incorporated by reference herein in its entirety.

### BACKGROUND

### 1. Field

Embodiments of the present disclosure relate to an anti-frost hydrogel coating composition including an ionic monomer, a method of preparing a hydrogel coating film using the anti-frost hydrogel coating composition, and a heat exchanger including the anti-frost hydrogel.

### 2. Description of the Related Art

Devices such as heat exchangers, airplanes, and wind power generators that operate in low-temperature environments experience condensation of moisture on their surfaces, resulting in a freezing phenomenon.

Typically, when aluminum fins used in heat exchangers are operated in a low-temperature environment, water vapor is liquefied on the surface of a fin material due to the difference in temperature between the heat exchanger and the outside, and the liquefied water freezes on the surface, causing a freezing phenomenon. The frost formed on the surface due to this freezing phenomenon acts as thermal resistance to lower thermal conductivity, and not only reduces cooling efficiency and energy efficiency but also accelerates corrosion to shorten the lifetime of the heat exchanger.

To solve these problems, a method is usually used to remove frost generated on the surface through a defrosting process that generally applies heat using a heater. However, this defrosting method has a problem of consuming additional power.

Accordingly, studies have been conducted to enhance energy efficiency during the cooling process by applying water-repellent treatment to the heat exchanger to reduce frost formed on the surface and reduce power consumption during the operation process by reducing the power consumption required for the defrosting process.

In this regard, Korean Patent Laid-Open No. 10-2022-0021234 discloses a configuration that reduces the freezing temperature by imparting hydrophilicity to the surface of aluminum metal using an ethylene glycol-based composition used in an anti-freeze, thereby reducing the freezing temperature of the metal surface.

### SUMMARY

Therefore, it is an aspect of the present disclosure to provide an anti-frost hydrogel coating composition using a superhydrophilic ionic monomer that has not been used for the purpose of preventing frost in the related art.

Additional aspects of the disclosure will be set forth in part in the description which follows and, in part, will be obvious from the description, or may be learned by practice of the disclosure.

In accordance with one aspect of the present disclosure, provided is a superhydrophilic hydrogel coating method capable of further lowering the freezing temperature of the surface of a substrate using a hydrogel coating composition including an ionic monomer having superhydrophilicity.

In accordance with another aspect of the present disclosure, provided is a heat exchanger having an effect of further enhancing ice nucleation and ice growth prevention performance and reducing ice adhesion by introducing a superhydrophilic ionic polymer hydrogel coating to the surface of a fin material surface in order to reduce the freezing temperature on the surface of a device operated in a low-temperature environment.

The technical problems which the present document intends to solve are not limited to the problems which have been mentioned above, and still other problems which have not been mentioned will be apparently understood by a person with ordinary skill in the art from the following description.

An anti-frost hydrogel coating composition according to the present disclosure includes an ionic monomer, a crosslinker including two or more acrylic groups, a polymerization initiator, and a solvent. The ionic monomer can include at least one ionic monomer from among a zwitterionic monomer, a cationic monomer, and an anionic monomer.

In accordance with another aspect of the present disclosure, the zwitterionic monomer can include an acrylic monomer including a zwitterionic functional group including at least one acrylic monomer including the zwitterionic functional group from among phosphorylcholine, sulfobetaine, and carboxybetaine.

In accordance with another aspect of the present disclosure, the zwitterionic monomer can include at least one zwitterionic monomer from among 2-methacryloyloxyethyl phosphorylcholine, 3-[[2-(methacryloyloxy)ethyl]dimethylammonio]propionate, and [2-(methacryloyloxy)ethyl]dimethyl-(3-sulfopropyl)ammonium hydroxide.

In accordance with another aspect of the present disclosure, the cationic monomer can be an acrylic monomer including a trialkylammonium cationic group at an end.

In accordance with another aspect of the present disclosure, the cationic monomer can include at least one cationic monomer from among [2-(methacryloyloxy)ethyl]trimethylammonium chloride and trimethyl-3-[(1-oxoallyl)amino]propylammonium chloride.

In accordance with another aspect of the present disclosure, the anionic monomer can be an acrylic monomer including a sulfonate anionic group at an end.

In accordance with another aspect of the present disclosure, the anionic monomer can include at least one anionic monomer from among 3-prop-2-enoyloxypropane-1-sulfonic acid, 3-(2-methylprop-2-enoyloxy)propane-1-sulfonic acid, and acrylic acid.

In accordance with another aspect of the present disclosure, the ionic monomer can include the cationic monomer and the anionic monomer.

In accordance with another aspect of the present disclosure, the two or more acrylic groups can include at least one acrylic group from among polyethylene glycol diacrylate, polyethylene glycol dimethacrylate, N,N′-methylenebisacrylamide, and trimethylolpropane triacrylate.

In accordance with another aspect of the present disclosure, a concentration of the crosslinker can range from 0.1 w/v % to 5.0 w/v %.

In accordance with another aspect of the present disclosure, the polymerization initiator can include at least one polymerization initiator from among a thermal polymerization initiator and a photopolymerization initiator.

In accordance with another aspect of the present disclosure, the anti-frost hydrogel coating can further comprise a reaction catalyst for activating the polymerization initiator.

A method of forming an anti-frost hydrogel coating film on a substrate according to the present disclosure includes: applying, on the substrate, an anti-frost hydrogel coating composition including an ionic monomer, a crosslinker including two or more acrylic groups, a polymerization initiator, and a solvent; and crosslinking and polymerizing the anti-frost hydrogel coating composition to form the anti-frost hydrogel coating film including an ionic polymer on the substrate. The ionic monomer can include at least one ionic monomer from among a zwitterionic monomer, a cationic monomer, and an anionic monomer.

In accordance with another aspect of the present disclosure, the method of forming an anti-frost hydrogel coating film on a substrate can further include: before the applying, surface-treating the substrate with a silane-based compound including an acrylic group to form an intermediate adhesive layer between the substrate and the anti-frost hydrogel coating film.

In accordance with another aspect of the present disclosure the ionic monomer can include the cationic monomer and the anionic monomer at an equivalent ratio of 1:1.

A heat exchanger according to the present disclosure, can include at least one of a fin and a tube having a film of an anti-frost hydrogel coating composition to reduce the freezing temperature on a surface of the at least one of the fin and the tube. The anti-frost hydrogel coating film composition can include an ionic monomer, a crosslinker including two or more acrylic groups, a polymerization initiator, and a solvent, the ionic monomer can include at least one ionic monomer from among a zwitterionic monomer, a cationic monomer, and an anionic monomer.

A heat exchanger according to the present disclosure, as a heat exchanger including a fin material, can include an anti-frost hydrogel coating film coated on the fin material. The anti-frost hydrogel coating film includes an ionic polymer copolymer.

An aspect of the present disclosure provides an anti-frost hydrogel coating composition using a superhydrophilic ionic monomer that has not been used for the purpose of preventing frost in the related art.

An aspect of the present disclosure provides a superhydrophilic hydrogel coating method capable of further lowering the freezing temperature of the surface of a substrate using a hydrogel coating composition including an ionic monomer having superhydrophilicity.

An aspect of the present disclosure provides a heat exchanger having an effect of further enhancing ice nucleation and ice growth prevention performance and reducing ice adhesion by introducing a superhydrophilic ionic polymer hydrogel coating on the surface of a fin material surface in order to reduce the freezing temperature on the surface of a device operated in a low-temperature environment.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a cross-sectional view of a substrate on which an anti-frost hydrogel coating film is formed according to an embodiment;

FIG. 2 is a cross-sectional view of a substrate on which an anti-frost hydrogel coating film according to an embodiment and an intermediate adhesive layer are formed;

FIG. 3 is a schematic view of a hydrogel coating film including an ionic polymer according to an embodiment;

FIG. 4 shows a water contact angle according to substrate surface treatment in an embodiment;

FIG. 5 shows the results of X-ray photoelectron spectroscopy (XPS) of the surfaces of a substrate before surface treatment in Experimental Example 1 and the substrates surface-treated in Preparation Examples 1 to 5;

FIG. 6 shows the results of measuring the differential scanning calorimetry (DSC) of the hydrogel coating film measured with two cycles in Experimental Example 2;

FIG. 7 shows the freezing temperature of an ionic polymer hydrogel analyzed through the DSC shown in FIG. 6;

FIG. 8 shows the results of free water and bound water Fourier transform-infrared spectroscopy (FT-IR) analysis of the ionic polymers in Experimental Example 3;

FIG. 9 shows the results of a wind tunnel experiment conducted at −10° C. on a common aluminum substrate and an aluminum substrate coated with hydrogel in Experimental Example 4; and

FIG. 10 shows the results of a wind tunnel experiment conducted at −30° C. on a common aluminum substrate and an aluminum substrate coated with hydrogel in Experimental Example 4.

### DETAILED DESCRIPTION

It should be understood that various embodiments of the present document and the terms used therein are not intended to limit the technical features set forth herein to particular embodiments and include various changes, equivalents, or replacements for a corresponding embodiment.

In connection with the description of the drawings, like reference numerals may be used for similar or related components.

It is to be understood that a singular form of a noun corresponding to an item may include one or more of the items, unless the relevant context clearly indicates otherwise.

As used herein, each of the phrases “A or B,” “at least one of A and B,” “at least one of A or B,” “A, B or C,” “at least one of A, B and C,” and “at least one of A, B, or C” may include any one of the listed items, or all possible combinations thereof.

The term “and/or” includes a combination of a plurality of related listed components, or any component among the plurality of related listed components.

Terms such as “first,” “second,” or “first” or “second” may be used simply to distinguish one component from other components, and do not limit the components in other aspects (e.g., importance or order).

Further, terms such as “front,” “rear,” “top,” “bottom,” “side,” “left side,” “right side,” “upper” and “lower” used in the present disclosure are defined based on the drawings, and the shape and location of each component are not limited by the terms.

The term “include” or “have” is intended to indicate the presence of a characteristic, number, step, operation, component, part or any combination thereof described in the present document, and the possibility of the presence or addition of one or more other characteristics or numbers, steps, operations, components, parts or any combination thereof is not precluded.

When a component is “connected,” “coupled,” “supported,” or “in contact” with another component, this includes not only cases in which components are directly connected, coupled, supported, or in contact with each other, but also cases in which they are indirectly connected, coupled, supported, or in contact through a third component.

When a component is disposed “on” another component, this includes not only a case in which the component is in contact with another component, but also a case in which still another member is present between the two components.

A term, such as “about” or “substantially,” is used at a corresponding numerical value or used as a meaning close to the numerical value when manufacturing and material tolerances inherent in the stated meaning are presented, and is used to prevent an unconscientious infringer from unfairly using disclosed contents including a numerical value illustrated as being accurate or absolute in order to help understanding of the present disclosure.

Hereinafter, an anti-frost hydrogel coating composition according to the present disclosure, a method of preparing the anti-frost hydrogel coating film, and a heat exchanger to which the same is applied will be specifically described.

The present disclosure provides an anti-frost hydrogel coating composition including an ionic monomer, a crosslinker, a polymerization initiator, and a solvent.

The anti-frost hydrogel coating composition according to the present disclosure may impart superhydrophilicity to the hydrogel coating by including an ionic monomer. Here, the ionic monomer means a polymer having an ionic functional group in the main chain or side chain of the molecule, and may include one or more monomers selected from the group consisting of a zwitterionic (+/−) monomer, a cationic (+) monomer, and an anionic (−) monomer. For example, it may be desirable to include one or more zwitterionic (+/−) monomers, or one or more cationic (+) monomers and one or more anionic (−) monomers, but is not limited thereto.

In an embodiment, the hydrogel coating composition may include the ionic monomer at a molar concentration of about 0.5 to 3 mol/L. When the molar concentration of the ionic monomer is too low, a hydrogel may not be generated due to the insufficient amount of the monomer, and when the molar concentration of the ionic monomer is too high, the hydrogel has highly brittle mechanical properties, making it unsuitable for application, so that it is desirable to satisfy the above molar concentration.

In an embodiment, when the hydrogel coating composition includes a zwitterionic monomer as an ionic monomer, it is possible to form a hydrogel coating including a zwitterionic polymer in which zwitterionic monomers are polymerized, and/or a copolymer thereof.

The zwitterionic monomer is a neutral chemical compound with both positive and negative charges, and includes at least one zwitterionic group and at least one reactive group in the main chain or side chain of the molecule. The zwitterionic group may include phosphoryl choline, sulfobetaine, carboxybetaine, and the like.

For example, the zwitterionic monomer may include 2-methacryloyloxyethyl phosphorylcholine (MPC) represented by the following Chemical Formula 1-1, 3-[[2-(methacryloyloxy)ethyl]dimethylammonio]propionate (CBMA) represented by the following Chemical Formula 1-2, [2-(methacryloyloxy)ethyl]dimethyl-(3-sulfopropyl)ammonium hydroxide (SBMA) represented by the following Chemical Formula 1-3, and the like.

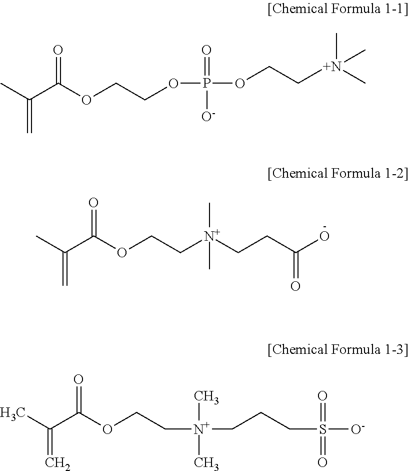

In an embodiment, when the hydrogel coating composition includes a cationic monomer as an ionic monomer, it is possible to form a hydrogel coating including a cationic polymer in which cationic monomers are polymerized, and/or a copolymer thereof.

A cationic monomer refers to a monomer that has a positive charge or can have a positive charge, and includes at least one cationic group in the main chain or side chain of the molecule. Specifically, the cationic monomer may be an acrylic monomer including a trialkylammonium cationic group at the end, and may be present in a solution state with an anionic salt such as a halide (chloride) salt.

For example, the cationic monomer may include [2-(methacryloyloxy)ethyl]trimethylammonium chloride (METAC) represented by the following Chemical Formula 2-1, trimethyl-3-[(1-oxoallyl)amino]propylammonium chloride represented by the following Chemical Formula 2-2, and the like.

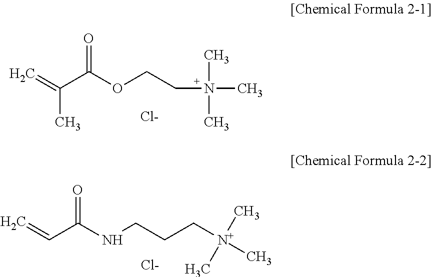

In an embodiment, when the hydrogel coating composition includes an anionic monomer as an ionic monomer, it is possible to form a hydrogel coating including an anionic polymer in which anionic monomers are polymerized, and/or a copolymer thereof.

An anionic monomer refers to a monomer that has a negative charge or can have a negative charge, and includes at least one anionic group in the main chain or side chain of the molecule. Specifically, the anionic monomer may be an acrylic monomer including a sulfonate anionic group at the end, and may be present in a solution state with a cationic salt such as a potassium salt.

For example, the anionic monomer may include 3-prop-2-enoyloxypropane-1-sulfonic acid; 3-sulfopropyl acrylate (SPA) represented by the following Chemical Formula 3-1, 3-(2-methylprop-2-enoyloxy)propane-1-sulfonic acid (3-sulfopropyl methacrylate; SPMA) represented by the following Chemical Formula 3-2, acrylic acid (AAc), and the like.

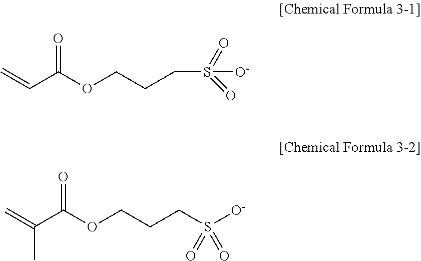

In an embodiment, the hydrogel coating composition may include both a cationic monomer and an anionic monomer as ionic monomers. In this case, it is possible to form a hydrogel coating including a pseudo-zwitterionic polymer in which a cationic monomer and a cationic monomer are polymerized and/or a copolymer thereof. In this case, in order to balance negative and positive charges, it is preferred that the cationic monomer and the anionic monomer are included at an equivalent ratio of about 1:1.

The hydrogel coating composition according to the present disclosure includes a crosslinker including an acrylic group to induce gelation by crosslinking and polymerization with an ionic monomer. The crosslinker can be used without any particular limitation as long as it is known as an acrylic crosslinker including two or more acrylic groups.

In an embodiment, the crosslinker may be included at a molar ratio of about 0.5 to 5 mol % based on the ionic monomer. In addition, the concentration of crosslinker in the hydrogel coating composition preferably ranges from 0.1 w/v % to 5.0 w/v %. When the molar ratio or concentration range of the crosslinker exceeds the above range, the brittleness is so strong that when a hydrogel coating film is subjected to an impact, the hydrogel coating film may be destroyed because defects are formed. In contrast, when the molar ratio or concentration range of the crosslinker is less than the above range, the crosslinking between the polymers is not sufficiently formed, so the hydrogel is not produced in the form of a solid hydrogel, but in a viscous liquid form. Therefore, by including the crosslinker within the above-described molar ratio or concentration range, a hydrogel with excellent elongation and strength may be stably formed on a substrate.

For example, the crosslinker including two or more acrylic groups may include polyethylene glycol diacrylate (PEGDA) represented by the following Chemical Formula 4-1, polyethylene glycol dimethacrylate represented by the following Chemical Formula 4-2, N, N′-methylenebisacrylamide represented by the following Chemical Formula 4-3, trimethylolpropane triacrylate represented by the following Chemical Formula 4-4, and the like, but is not limited thereto.

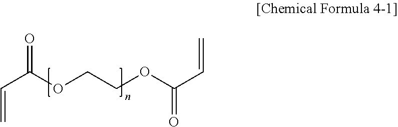

In Chemical Formula 4-1, n is any integer.

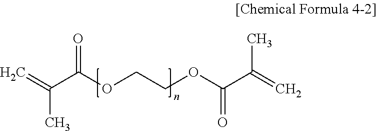

In Chemical Formula 4-2, n is any integer.

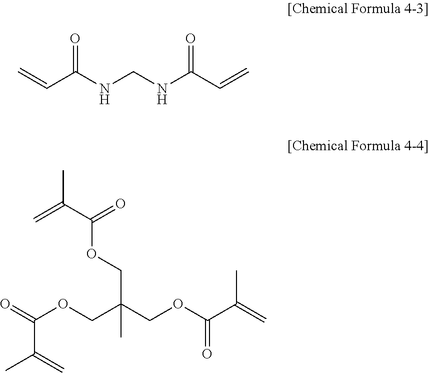 [SMILES: C=CC(=O)NCNC(=O)C=C ; C=C(C)C(=O)OCC(C)(COC(=O)C(=C)C)COC(=O)C(=C)C]

The hydrogel coating composition according to the present disclosure includes a polymerization initiator for polymerizing the ionic monomer by forming radicals in the ionic monomer. The polymerization initiator does not polymerize the polymer chains, but may or may not be present in the prepared polymer hydrogel.

The polymerization initiator is a material that forms radicals by external stimulation such as heat and/or light, and may include one or more initiators selected from the group consisting of a thermal polymerization initiator and a photopolymerization initiator depending on the polymerization method.

As the thermal polymerization initiator, it is possible to use one or more selected from the group of initiators consisting of a persulfate-based initiator and an azo-based initiator. Specifically, examples of the persulfate-based initiator include ammonium persulfate (APS) represented by the following Chemical Formula 5-1, sodium persulfate (Na₂S₂O₈), potassium persulfate (K₂S₂O₈), and the like, and examples of the azo-based initiator include 4,4-azobis-(4-cyanovaleric acid) represented by the following Chemical Formula 5-2, 2,2-azobis(2-amidinopropane) dihydrochloride, 2,2-azobis-(N,N-dimethylene)isobutyramidine dihydrochloride, 2-carbamoyl azoisobutylonitrile, 2,2-azobis[2-(2-imidazolin-2-yl)propane] dihydrochloride, and the like, but are not limited thereto.

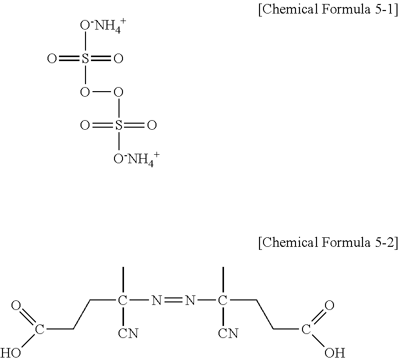

The photopolymerization initiator can be used without any particular limitation as long as it is a compound capable of forming radicals by light such as ultraviolet (UV) light. The photopolymerization initiator may include, for example, 2-hydroxy-4′-(2-hydroxyethoxy)-2-methylpropiophenone (IRGACURE 2959) represented by the following Chemical Formula 6, 2-hydroxy-2-methyl-1-phenyl-propan-1-one (DAROCUR 1173), IRGACURE 500, IRGACURE 754, IRGACURE OXE02, and the like, but is not limited thereto.

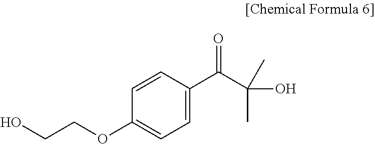 [SMILES: CC(C)(O)C(=O)c1ccc(OCCO)cc1]

The polymerization initiator may be included at a molar ratio of 0.5 to 2.5 mol % based on the ionic monomer. When the molar ratio of the polymerization initiator is too low, the rate of radical generation is slower than the rate of radical extinction, so that polymerization may not be initiated by radicals. However, when the molar ratio of the polymerization initiator is too high, there is a concern that the mechanical properties of the hydrogel may be weakened.

In addition, the hydrogel coating composition according to the present disclosure may further include a reaction catalyst for activating the polymerization initiator.

For example, when ammonium persulfate (APS) is used as a polymerization initiator, tetramethylethylenediamine (TEMED) represented by the following Chemical Formula 7 may be further included as a reaction catalyst for promoting the reaction thereof.

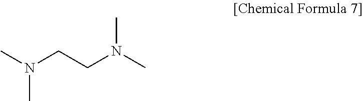

Furthermore, the hydrogel coating composition according to the present disclosure includes a solvent. The solvent can be used without any limitation in composition as long as it can dissolve the above-described components. As the solvent, it is possible to use a combination of one or more selected from among, for example, water, ethanol, ethylene glycol, diethylene glycol, triethylene glycol, 1,4-butanediol, propylene glycol, ethylene glycol monobutyl ether, propylene glycol monomethyl ether, propylene glycol monomethyl ether acetate, diethylene glycol monomethyl ether, diethylene glycol ethylether, carbitol, and the like, and water is most preferable.

The solvent may be included in the residual amount of the composition excluding the above-described components with respect to the total content of the composition.

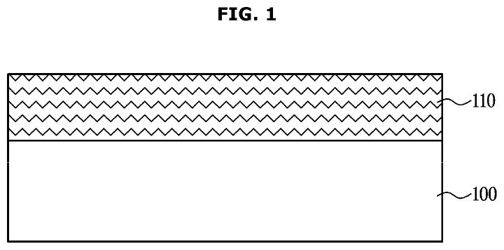

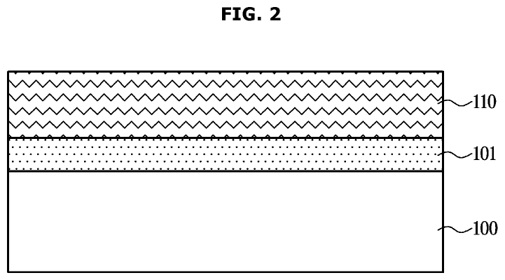

Hereinafter, a method of preparing an anti-frost hydrogel coating film will be described with reference to FIGS. 1 and 2. FIGS. 1 and 2 are cross-sectional views of a substrate on which an anti-frost hydrogel coating film is formed.

Referring to FIG. 1, the anti-frost hydrogel coating film according to the present disclosure is prepared by applying the anti-frost hydrogel coating composition on a substrate 100 and then crosslinking and polymerizing the hydrogel coating composition to form a hydrogel coating film 110.

The substrate 100 is a common inorganic material, preferably a metal material. The substrate 100 may be, for example, alumino-silicates such as aluminum, an aluminum alloy, silica, quartz, glass, and clays, inorganic oxides such as silicon, copper, tin (SnO), talc, Fe₂O₃, TiO₂, and Cr₂O₃, steel, iron, and the like, but is not limited thereto.

Referring to FIG. 2, the method of preparing an anti-frost hydrogel coating film according to the present disclosure may further include forming an intermediate adhesive layer 101 by surface-treating the substrate 100 with a silane-based compound including an acrylic group before applying the anti-frost hydrogel coating composition on the substrate 100.

Further, the method may further include treating the surface of the substrate 100 with UV in order to clean the surface of the substrate 100 before forming the intermediate adhesive layer 101, and treating the surface of the substrate 100 with ozone to form a hydroxy group on the surface of the substrate 100 so as to facilitate bonding with silane.

The intermediate adhesive layer 101 may be formed to prevent the substrate 100 and the hydrogel 110 from being separated from each other due to swelling of the hydrogel.

In an embodiment, an acrylic group may be formed on the surface of the substrate 100 by surface treating the substrate 100 using a silane-based compound including an acrylic group as a silane coupling agent to form an intermediate adhesive layer 101. The acrylic group on the surface of the substrate 100 enables hydrogel grafting, which forms strong chemical bonds between the hydrogel coating film 110 and the surface of the substrate 100. Therefore, the hydrogel coating film 110 may be stably maintained on the surface of the substrate 100 through the acrylic group formed on the surface of the substrate.

In addition, silane has versatility in various processes because it is possible to increase adhesion and affinity between a polymer and an inorganic, organic, metal, or glass material in a composite system of the polymer and the inorganic, organic, metal, or glass material, and form an adhesive group on the surface of the substrate by simple heat treatment. Furthermore, wettability is required for a thin hydrogel to be formed on the surface of a substrate, and silane may be used to increase the wettability of the substrate, and thus, may facilitate the formation of a hydrogel coating film 110 on the surface of the substrate.

For example, the silane-based compound including an acrylic group may include methacryloxypropyltrimethoxysilane (TMSPMA), (3-acryloxypropyl)trimethoxysilane, methacryloxypropylmethyldimethoxylane, and the like.

As an example, the intermediate adhesive layer 101 may be formed by preparing a silane solution including a silane compound including an acrylic group and a solvent, immersing the substrate 100 in the silane solution, and then reacting the substrate 100 at room temperature or heat-treating the substrate 100. For example, the heat treatment may be performed at 60 to 100° C. for 30 minutes to 3 hours, but is not limited thereto.

In an embodiment, an anti-frost hydrogel coating composition is applied on a substrate 100 with or without an intermediate adhesive layer 101 formed thereon.

The anti-frost hydrogel coating composition includes an ionic monomer, a crosslinker including two or more acrylic groups, a polymerization initiator, and a solvent, and the detailed description thereof is the same as the content described above, and thus, is omitted.

The hydrogel coating composition may be applied by a method such as dip coating, casting, and spray coating. In this case, the thickness of the hydrogel coating film may be appropriately adjusted, if necessary.

Subsequently, a hydrogel coating film 110 including an ionic polymer is formed on the substrate 100 with or without the intermediate adhesive layer 101 formed thereon by crosslinking and polymerizing the anti-frost hydrogel coating composition.

In an embodiment, in order to crosslink and polymerize the hydrogel coating composition, the hydrogel coating film 110 may be formed by performing heat treatment and/or light irradiation to induce curing.

For example, when the hydrogel coating composition includes a thermal polymerization initiator as a polymerization initiator, the hydrogel coating film 110 may be formed by inducing curing of the hydrogel coating composition through heat treatment. In this case, the heat treatment may be performed in an oven at 60 to 100° C.

For example, when the hydrogel coating composition includes a photopolymerization initiator as a polymerization initiator, the hydrogel coating film 110 may be formed by inducing curing of the hydrogel coating composition through light irradiation. In this case, light irradiation may be irradiation using a light source in the UV region.

For example, when the hydrogel coating composition includes both a thermal polymerization initiator and a photopolymerization initiator, both heat treatment and light irradiation may be performed to induce curing of the hydrogel coating composition.

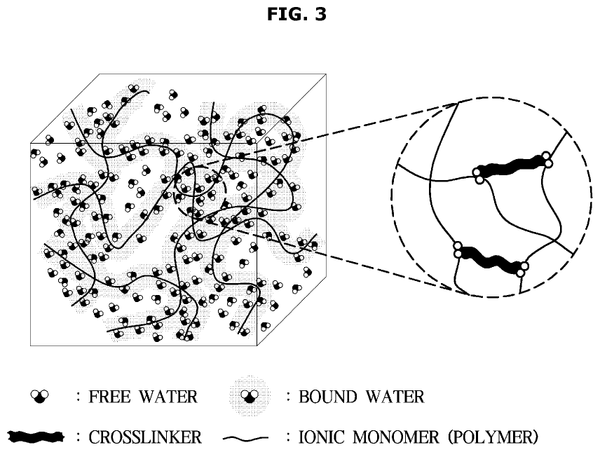

FIG. 3 is a schematic view of a hydrogel coating film 110 including an ionic polymer. Referring to FIG. 3, the hydrogel coating film 110 includes free water and bound water surrounding the ionic polymer, and ionic monomers are bonded to each other by a crosslinker and polymerized into ionic polymers. The polymerization initiator does not polymerize ionic polymer chains, but may or may not be present in the hydrogel coating film 110.

In an exemplary example, the ionic polymer may include one or more polymers selected from the group consisting of a zwitterionic polymer, a cationic polymer, an anionic polymer, and a pseudo-zwitterionic polymer. Here, the pseudo-zwitterionic polymer may mean that the hydrogel coating film 110 includes both a cationic polymer and an anionic polymer.

For example, the ionic polymer may include a zwitterionic polymer represented by the following Chemical Formula 8-1, a cationic polymer represented by the following Chemical Formula 8-2, an anionic polymer represented by the following Chemical Formula 8-3, and the like, but is not limited thereto.

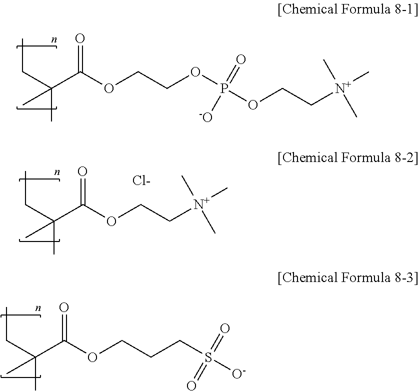

In Chemical Formulae 8-1 to 8-3, n is each independently any integer, + means electrically cationic, and − means electrically anionic.

Further, the cured hydrogel coating film 110 may achieve an appropriate moisture content (about 30 to 50 wt %) for maintaining physical properties and a structure by drying at an appropriate level under constant temperature and constant humidity conditions.

In an embodiment, the hydrogel coating film 110 may be formed with a thickness of 10 nm to 1 mm, preferably 100 nm to 500 μm. When the above thickness range is satisfied, both optimal anti-icing performance and hydrogel coating stability can be achieved.

The anti-frost hydrogel coating film according to the present disclosure may retard the generation and growth of frost on the substrate by lowering the freezing temperature. For example, the freezing temperature of the hydrogel coating film may be about −18.5° C. or less, preferably about −25° C. or less, more preferably about −27° C. or less. The lower the freezing temperature of the hydrogel coating film, the better the anti-icing performance the hydrogel coating film may have.

The hydrogel coating film according to an embodiment can be used without any particular limitations on the surface of products that require anti-icing performance. The hydrogel coating film prepared according to the present disclosure may also be applied to, for example, fin materials of heat exchangers; transport passages such as pipes and power lines; and external surfaces of aircraft such as aircraft, artificial satellites, and spacecraft, but is not limited thereto.

Hereinafter, a heat exchanger including a fin material will be described as an example to which the anti-frost hydrogel coating film according to the present disclosure is applied.

The heat exchanger includes a tube having a channel formed therein such that a refrigerant flows therein, and an evaporator including a fin coupled to an outer circumferential surface of the tube.

Further, the tube may be provided so as to be connected in multiple rows of zigzags to increase the heat exchange area between the refrigerant flowing inside the tube and the external air.

A plurality of fins may be provided, and an aluminum alloy may be used as a fin material. In addition, in order to improve the anti-icing performance of the heat exchanger, the fin material may be coated with the anti-frost hydrogel according to the present disclosure.

A detailed description of the anti-frost hydrogel is omitted because it is the same as that described above regarding the above described anti-frost hydrogel coating composition and the method of preparing a hydrogel coating film using the same.

In an embodiment, the fin may be provided between a plurality of tubes such that the refrigerant flowing along the channels formed inside the tubes and the external air can efficiently exchange heat. That is, the fin may be disposed in contact with the tube in the heat exchange space.

In an embodiment, the fin may be provided along the outer circumferential surface of the first tube in the longitudinal direction of the tube. In this case, the form of the fin is not particularly limited.

In an embodiment, the fin may be coupled to the tube by press-fitting. That is, the tube and the fin may be coupled by pushing the fin, which is smaller than the outer diameter of the tube, into the tube.

The anti-frost hydrogel coating composition according to an embodiment includes an ionic monomer, a crosslinker including two or more acrylic groups, a polymerization initiator, and a solvent. The ionic monomer includes one or more monomers selected from the group consisting of a zwitterionic monomer, a cationic monomer, and an anionic monomer.

The zwitterionic monomer may be an acrylic monomer including a zwitterionic functional group selected from the group consisting of phosphorylcholine, sulfobetaine, and carboxybetaine.

The zwitterionic monomer may be selected from the group consisting of 2-methacryloyloxyethyl phosphorylcholine, 3-[[2-(methacryloyloxy)ethyl]dimethylammonio]propionate, and [2-(methacryloyloxy)ethyl]dimethyl-(3-sulfopropyl)ammonium hydroxide.

The cationic monomer may be an acrylic monomer including a trialkylammonium cationic group at the end.

The cationic monomer may be selected from the group consisting of [2-(methacryloyloxy)ethyl]trimethylammonium chloride and trimethyl-3-[(1-oxoallyl)amino]propylammonium chloride.

The anionic monomer may be an acrylic monomer including a sulfonate anionic group at the end.

The anionic monomer may be selected from the group consisting of 3-prop-2-enoyloxypropane-1-sulfonic acid, 3-(2-methylprop-2-enoyloxy)propane-1-sulfonic acid, and acrylic acid.

The ionic monomer may include the cationic monomer and the anionic monomer.

The crosslinker including two or more acrylic groups may include one or more selected from the group consisting of polyethylene glycol diacrylate, polyethylene glycol dimethacrylate, N,N′-methylenebisacrylamide, and trimethylolpropane triacrylate.

The concentration of the crosslinker may range from 0.1 w/v % to 5.0 w/v %.

The polymerization initiator may include one or more selected from the group consisting of a thermal polymerization initiator and a photopolymerization initiator.

The hydrogel coating composition may further include a reaction catalyst for activating the polymerization initiator.

A method of preparing an anti-frost hydrogel coating film according to an embodiment includes: applying an anti-frost hydrogel coating composition including an anionic monomer, a crosslinker including two or more acrylic groups, a polymerization initiator, and a solvent on a substrate; and forming a hydrogel coating film including an ionic polymer on the substrate by crosslinking and polymerizing the anti-frost hydrogel coating composition. The ionic monomer includes one or more monomers selected from the group consisting of a zwitterionic monomer, a cationic monomer, and an anionic monomer.

The method may further include forming an intermediate adhesive layer by surface-treating the substrate with a silane-based compound including an acrylic group before applying the anti-frost hydrogel coating composition on the substrate.

The silane-based compound including an acrylic group may include one or more compounds selected from the group consisting of methacryloxypropyltrimethoxysilane, (3-acryloxypropyl)trimethoxysilane, and methacryloxypropylmethyldimethoxylane.

The ionic polymer may include one or more polymers selected from the group consisting of a zwitterionic polymer, a cationic polymer, an anionic polymer, and a pseudo-zwitterionic polymer.

The ionic monomer may include the cationic monomer and the anionic monomer at an equivalent ratio of 1:1.

The zwitterionic monomer may be selected from the group consisting of 2-methacryloyloxyethyl phosphorylcholine, 3-[[2-(methacryloyloxy)ethyl]dimethylammonio]propionate, and [2-(methacryloyloxy)ethyl]dimethyl-(3-sulfopropyl)ammonium hydroxide. The cationic monomer may be selected from the group consisting of [2-(methacryloyloxy)ethyl]trimethylammonium chloride and trimethyl-3-[(1-oxoallyl)amino]propylammonium chloride. The anionic monomer may be selected from the group consisting of 3-prop-2-enoyloxypropane-1-sulfonic acid, 3-(2-methylprop-2-enoyloxy)propane-1-sulfonic acid, and acrylic acid.

The heat exchanger according to an embodiment, as a heat exchanger including a fin material, includes an anti-frost hydrogel coating film coated on the fin material. The anti-frost hydrogel coating film includes an ionic polymer copolymer.

The ionic polymer copolymer may include one or more selected from the group consisting of a zwitterionic functional group, a cationic functional group, and an anionic functional group.

According to the idea of the present disclosure, a hydrogel may be formed using an ionic-based superhydrophilic material that has never been used for anti-frost (antifreeze) purposes, thereby providing an anti-frost effect.

According to the idea of the present disclosure, by coating the surface of a device operated in a low-temperature environment with a hydrogel including an ionic polymer, it is possible to provide the effects of suppressing ice nucleation, preventing ice growth, and reducing ice adhesion.

The technical effects which can be obtained from the present disclosure are not limited to the effects mentioned above, and other effects which have not been mentioned will be apparently understood by a person of ordinary skill in the art to which the present disclosure pertains from the following description.

Hereinafter, the present disclosure will be described in more detail through Examples. However, the following Examples are provided only for more specifically describing the present disclosure, and the scope of the present disclosure is not limited by the following Examples.

### Examples

### (1) Substrate Surface Treatment (Formation of Intermediate Adhesive Layer)

### (1-1) Preparation of Aluminum Substrate

After an aluminum substrate was washed with acetone, ethanol, and DI water in this order, the solution remaining on the surface of the substrate was removed and the substrate was dried at 70° C. to prepare an aluminum substrate (bare Al) before surface treatment.

### (1-2) Preparation of Silane Solution

A silane solution was prepared by adding 3-[trimethoxysilyl]propyl methacrylate (TMSPMA) at 2 wt % (TMSPMA/acetic acid aqueous solution) in an acetic acid (0.01 vol %) aqueous solution with a concentration of about 1 mM.

### (1-3) Aluminum Substrate Surface Treatment

Preparation Example 1: The washed aluminum substrate was additionally cleaned and treated with ozone using a UV/ozone cleaner to prepare an aluminum substrate (Al+UV/O₃).

Preparation Example 2: The washed aluminum substrate (bare Al) was placed in the previously prepared silane solution and reacted at room temperature (RT) for 2 hours. Thereafter, the substrate was washed with ethanol to prepare an aluminum substrate (Al+TMSPMA) whose surface was treated with silane.

Preparation Example 3: The washed aluminum substrate (bare Al) was placed in the previously prepared silane solution and reacted at 70° C. for 2 hours. Thereafter, the substrate was washed with ethanol to prepare an aluminum substrate (Al+TMSPMA @70° C.) whose surface was treated with silane.

Preparation Example 4: The ozone-treated aluminum substrate of Preparation Example 1 was placed in the previously prepared silane solution and reacted at room temperature (RT) for 2 hours. Thereafter, the substrate was washed with ethanol to prepare an aluminum substrate (Al+UV/O3+TMSPMA) whose surface was treated with ozone and silane.

Preparation Example 5: The ozone-treated aluminum substrate of Preparation Example 1 was placed in the previously prepared silane solution and reacted at 70° C. for 2 hours. Thereafter, the substrate was washed with ethanol to prepare an aluminum substrate (Al+UV/O3+TMSPMA @° C.) whose surface was treated with ozone and silane.

### (1-4) Experimental Example 1: Water Contact Angle Measurement and Elemental Analysis of Substrate

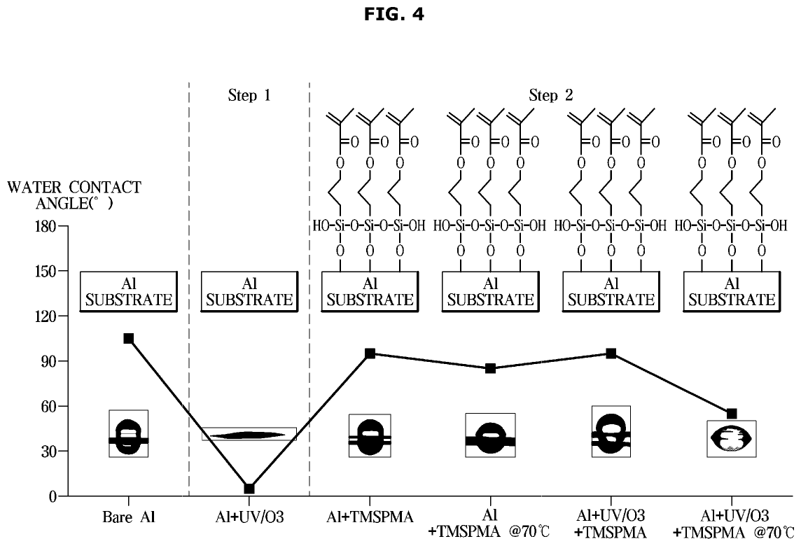

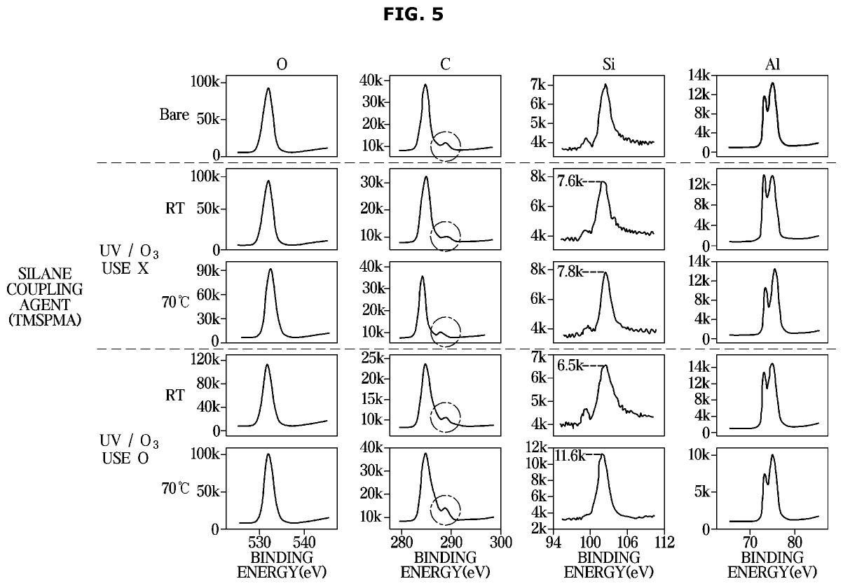

In order to select an appropriate surface treatment process, before surface treatment, water contact angles were measured for the aluminum substrate (bare Al) before surface treatment and the substrate immediately after the surface treatment was completed (Preparation Examples 1 to 5) as shown in FIG. 4, and surface elements were analyzed through X-ray photoelectron spectroscopy (XPS) as shown in FIG. 5. Accordingly, it was possible to verify the presence or absence of the silane reaction on the surface of the substrate.

Referring to FIG. 4, the substrate before surface treatment (bare Al) showed a contact angle of about 100°, but for the substrate after ozone treatment (Preparation Example 1), the contact angle decreased to about 0° because hydroxy groups were formed on the surface thereof. After reaction with the silane solution (Preparation Examples 2 to 4), the contact angle remarkably increased, showing a contact angle of at least 60°. This is due to the relatively hydrophobic silicon element being distributed on the surface through the surface treatment process, and it can be confirmed through this that the surface treatment was normally performed. Furthermore, when heat treatment was performed during silane treatment, the water contact angle tended to decrease, but it can be confirmed through this that wettability has been imparted by the heat-treated silane.

Further, referring to FIG. 5, through the fact that, in the carbon peak of the surface-treated substrate, the intensity of the shoulder peak derived from C═O and the silicon peak was higher than that of the substrate without surface treatment, it can be confirmed that the surface treatment was normally performed.

### (2) Preparation of Hydrogel Coating Film

### (2-1) Examples 1-1 to 1-5 and Comparative Example 1-1: Preparation of Hydrogel Coating Composition

After 1 mol % of the ionic monomer or nonionic monomer (2 to 3 mol/L as a molar concentration) as shown in the following Table 1, polyethylene glycol diacrylate ((PEGDA), stabilized with MEHQ, Tokyo Chemical Industry; 1 mol % compared to the monomer) and ammonium persulfate (APS, ≥98%, Sigma Aldrich, 1 mol % compared to the monomer) were put into a vial at a molar ratio of 1:0.01:0.01, the resulting mixture was stirred together with water as a solvent to obtain a hydrogel coating composition.

TABLE 1

| Classifica- | | Type of |
|---|---|---|
| tion | Type of monomer | ionicity |
| Example 1-1 | 2-Methacryloyloxyethyl phosphorylcholine | Zwitterionic |
| | (MPC) | |
| Example 1-2 | 3-[[2-(Methacryloyloxy)ethyl]dimethyl- | Zwitterionic |
| | ammonio]propionate (CBMA) | |
| Example 1-3 | [2-(Methacryloyloxy)ethyl]trimethyl- | Cationic |
| | ammonium chloride (METAC) | |
| Example 1-4 | 3-Prop-2-enoyloxypropane-1-sulfonic acid | Anionic |
| | (SPA) | |
| Example 1-5 | METAC + SPA | Cationic + |
| | | Anionic |
| Comparative | Oligo(ethylene glycol)methacrylate | Nonionic |
| Example 1-1 | (OEGMA) | (neutral) |

(2-2) Examples 2-1 to 2-5 and Comparative Example 2-1: The previously prepared hydrogel coating compositions according to Examples 1-1 to 1-5 and Comparative Example 1-1 were each cast on the substrate according to Preparation Example 5, and then cured in an oven at 70° C. for 30 minutes to prepare the hydrogel coating films of Examples 2-1 to 2-5 and Comparative Example 2-1. Thereafter, the cured hydrogel coating film was dried under constant temperature and constant humidity conditions (4° C. desiccator) for 10 to 14 hours to ensure that the hydrogel coating film contained an appropriate amount of moisture (about 30 to 50 wt %).

### (2-3) Experimental Example 2: Freezing Temperature Test Using Differential Scanning Calorimetry (DSC)

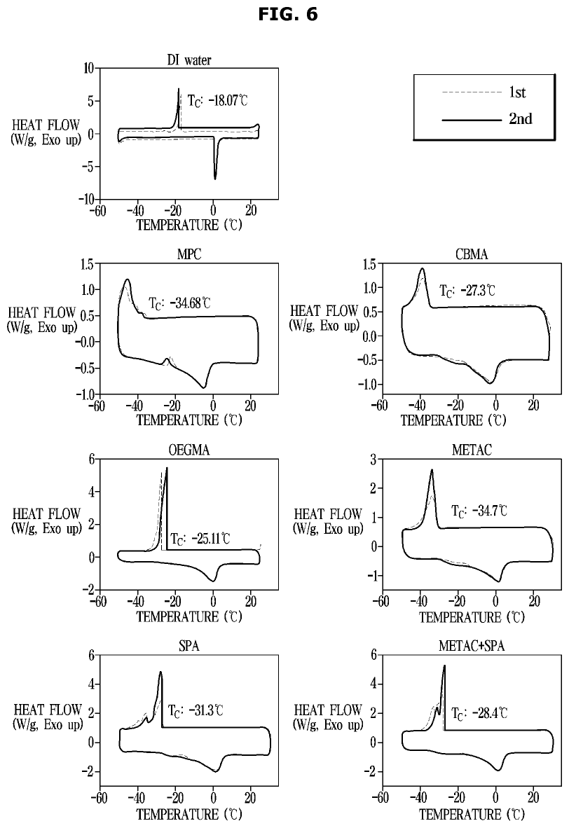

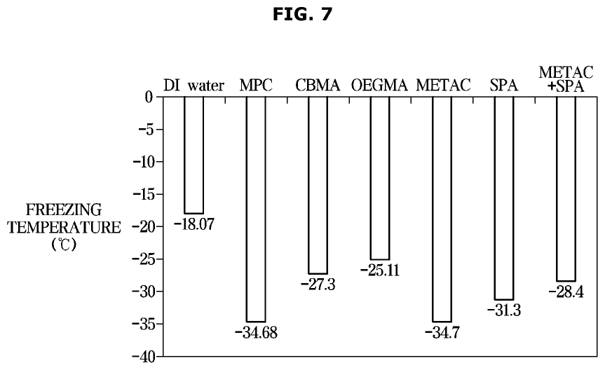

In order to confirm the anti-icing performance of the hydrogel coating film in a low-temperature environment, the freezing temperature of the hydrogel in the hydrogel coating films of Examples 2-1 to 2-5 and Comparative Example 2-1 was measured for two cycles using DSC, and the results are shown in FIGS. 6 and 7 and the following Table 2. Through the present experiment, a time point at which ice nucleation begins inside the hydrogel could be confirmed.

TABLE 2

| | Type of | Type of polymer | Freezing |
|---|---|---|---|
| Classification | monomer | ionicity | temperature (° C.) |
| Control (water) | — | — | −18.07 |
| Example 2-1 | Example 1-1 | MPC: Zwitterionic | −34.68 |
| Example 2-2 | Example 1-2 | CBMA: Zwitterionic | −27.3 |
| Example 2-3 | Example 1-3 | METAC: Cationic | −34.7 |
| Example 2-4 | Example 1-4 | SPA: Anionic | −31.3 |
| Example 2-5 | Example 1-5 | METAC + SPA: | −28.4 |
| | | Analogous zwitterionic | |
| Comparative | Comparative | OEGMA: Nonionic | −25.11 |
| Example 2-1 | Example 1-1 | | |

Referring to FIGS. 6 and 7 and Table 2 above, Example 2-1 (MPC) and Example 2-2 (CBMA) prepared based on zwitterionic monomers showed a freezing temperature of about −34.68° C. and −27.3° C., respectively. Example 2-3 (METAC) prepared based on a cationic monomer showed a freezing temperature of −34.7° C., and Example 2-4 (SPA) prepared based on an anionic monomer showed a freezing temperature of −31.3° C. In addition, Example 2-5 (METAC+SPA) including a pseudo-zwitterionic polymer prepared using METAC, which is a cationic monomer, and SPA, which is an anionic monomer, showed a freezing temperature of about −28.4° C. That is, it could be confirmed that when a hydrogel coating film including an ionic polymer was formed, the anti-icing performance was excellent because the freezing temperature was remarkably decreased. Meanwhile, it was confirmed that Comparative Example 2-1 (OEGMA) prepared based on a nonionic monomer had a freezing temperature of −25.11° C., which was lower than that of water (DI water). This is considered to be because the effect of lowering the freezing temperature due to the hydrophilicity of the hydrogel appears. However, it could be confirmed that the freezing temperature was lower when an ionic monomer was used than that when a nonionic monomer was used.

### (2-4) Experimental Example 3: Analysis of Physical State of Water Inside Hydrogel

Through the analysis of the DSC results in FIG. 6, it can be confirmed that the hydrogel coating films according to Examples 2-1 to 2-5 have a higher fraction of bound water that freezes at a temperature of −20 to −30° C. or lower than free water that freezes at 0° C. This is considered to be due to the interference with the hydrogen bonding between water molecules and the formation of a hexagonal structure for ice nucleation by improving the interaction with water molecules due to the cationic and anionic structure of zwitterionicity.

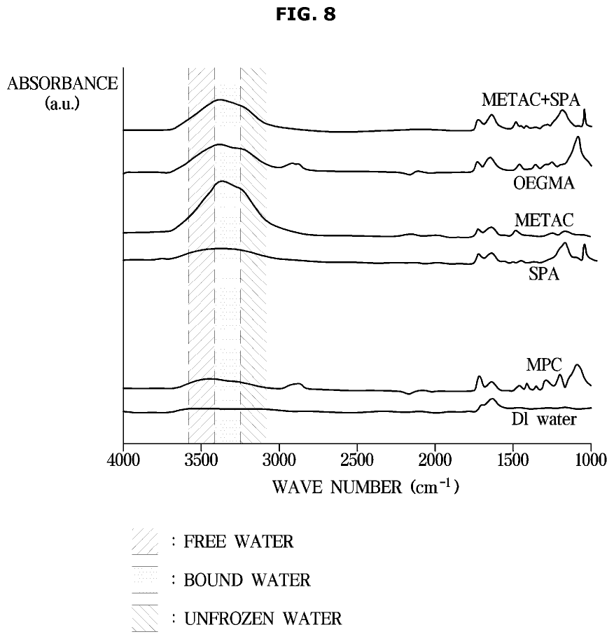

Furthermore, in order to quantitatively confirm the basis of the excellent anti-icing performance of the hydrogel coating film according to the present disclosure, Fourier transform-infrared spectroscopy (FT-IR) analysis was performed, and the results are shown in FIG. 8. Through this analysis, the water present in the zwitterionic hydrogel was separated according to the physical state thereof, and each fraction was calculated.

Referring to FIG. 8, it can be confirmed that, for the hydrogel coating film prepared by the method according to the present disclosure, the fraction of the 3200 cm⁻¹ peak of bound water caused by the interaction with ions is more dominant than the 3400 cm⁻¹ peak caused by O—H stretching of free water. That is, the content of bound water, which is completely restrained by the influence of the electrostatic force caused by the ions of the ionic polymer functional group, increases, so the hydrogel coating film including the ionic polymer appears to have a low freezing temperature (Tc).

### (2-5) Experimental Example 4: Surface Frost Generation and Growth Test by Wind Tunnel Experiment

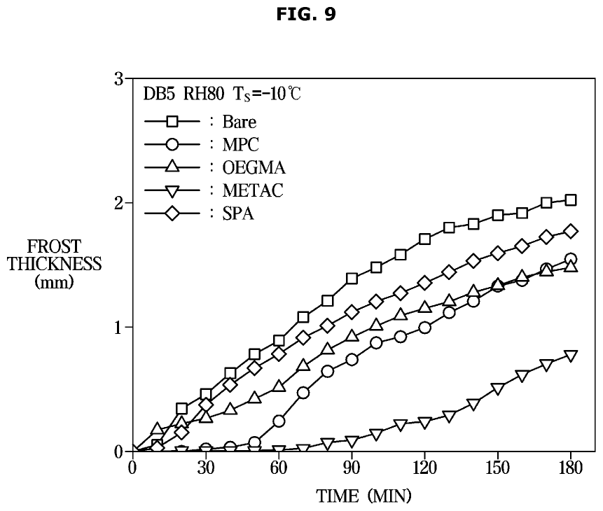

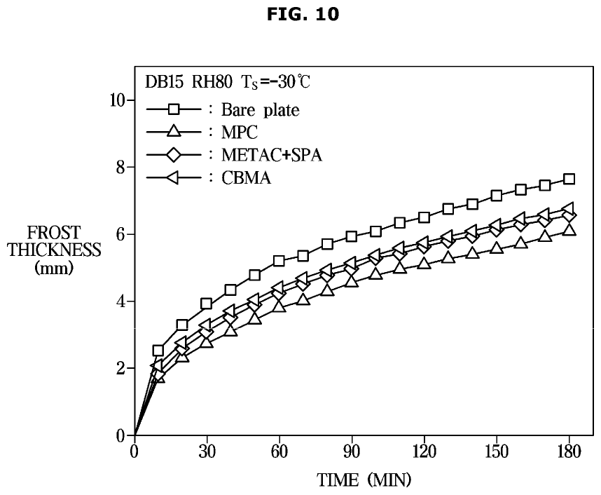

The substrates on which the hydrogel coating films of Examples 2-1 to 2-5 and Comparative Example 2-1 according to the present disclosure were formed were mounted in a wind tunnel experiment device constructed in a chamber having a constant humidity (RH80%) and a constant temperature (Tₛ=−10° C. or Tₛ=−30° C.) to measure the time taken for frost to be formed on the surface of the coating film and the thickness of the frost over time, and the results are shown in FIGS. 9 and 10.

Specifically, the experimental equipment was a modified version of an actual heat exchanger measuring device, and experiments were performed by including a Peltier element, a water-cooling cooler, a CMOS camera, an electron microscope, and the like. The surface temperature was controlled using a Peltier element and a water-cooling cooler. Further, the side of the substrate was observed using a CMOS camera, and the front surface was observed using an electron microscope.

For the experimental environment, a constant temperature and constant humidity chamber was used to maintain constant external air conditions (dry and wet bulb temperature), and a wind tunnel experiment device was used to adjust the surface temperature and air volume. Under the external air conditions during the experiment, the dry bulb and wet bulb temperatures were maintained at 5° C. and 3.6° C., respectively, the surface temperature (Tₛ) was set at −10° C. or −30° C., and the air volume was set at 1.3 CMM. In addition, the experiment was performed for 3 hours, and for the time taken for frost to be generated and grown on the surface, the sample surface was observed with a camera to determine the generation and growth of frost on the surface and measure the thickness of the frost.

First, at a humidity of 80% RH and a surface temperature of −10° C., a common aluminum substrate before hydrogel coating as a control (bare) and substrates coated with the hydrogels according to Example 2-1 (MPC), Example 2-3 (METAC), Example 2-4 (SPA), and Comparative Example 2-1 (OEGMA) were subjected to an frost formation experiment, and the results are shown in FIG. 9.

Referring to FIG. 9, in the case of Example 2-1 (MPC), Example 2-3 (METAC), and Example 1-4 (SPA) including ionic polymers, the generation of frost was delayed compared to the control, and the frost thickness was also thinner than that of the control. In contrast, Comparative Example 2-1 (OEGMA) including a nonionic polymer had a slower growth rate than the control, but the generation of frost began earlier than the control, so that it could be confirmed that there was no effect on delaying frost formation.

Furthermore, at a humidity of 80% RH and a surface temperature of −30° C., a common aluminum substrate before hydrogel coating as a control (bare) and substrates coated with the hydrogels according to Example 2-5 (MPC), Example 2-2 (CBMA), and Example 2-5 (METAC+SPA) were subjected to a frost formation experiment, and the results are shown in FIG. 10.

Referring to FIG. 10, it could be confirmed that Example 2-1 (MPC), Example 2-2 (CBMA), and Example 2-5 (METAC+SPA) including ionic polymers according to the present disclosure showed slower growth rates than that of the control.

As is apparent from the above description, the hydrogel coating film prepared by the method according to the present disclosure can exhibit excellent frost inhibition performance.

Although a few embodiments of the present disclosure have been shown and described, it would be appreciated by those skilled in the art that changes may be made in these embodiments without departing from the principles and idea of the disclosure, the scope of which is defined in the claims and their equivalents.

What is claimed is:

1. An anti-frost hydrogel coating composition comprising:
an ionic monomer;
a crosslinker including two or more acrylic groups;
a polymerization initiator; and
a solvent,
wherein the ionic monomer includes at least one ionic monomer from among a zwitterionic monomer, a cationic monomer, and an anionic monomer.

2. The anti-frost hydrogel coating composition of claim 1, wherein the zwitterionic monomer is an acrylic monomer including a zwitterionic functional group including at least one acrylic monomer including the zwitterionic functional group from among phosphorylcholine, sulfobetaine, and carboxybetaine.

3. The anti-frost hydrogel coating composition of claim 1, wherein the zwitterionic monomer includes at least one zwitterionic monomer from among 2-methacryloyloxyethyl phosphorylcholine, 3-[[2-(methacryloyloxy)ethyl]dimethylammonio]propionate, and [2-(methacryloyloxy)ethyl]dimethyl-(3-sulfopropyl)ammonium hydroxide.

4. The anti-frost hydrogel coating composition of claim 1, wherein the cationic monomer is an acrylic monomer including a trialkylammonium cationic group at an end.

5. The anti-frost hydrogel coating composition of claim 1, wherein the cationic monomer includes at least one cationic monomer from among [2-(methacryloyloxy)ethyl]trimethylammonium chloride and trimethyl-3-[(1-oxoallyl)amino]propylammonium chloride.

6. The anti-frost hydrogel coating composition of claim 1, wherein the anionic monomer is an acrylic monomer including a sulfonate anionic group at an end.

7. The anti-frost hydrogel coating composition of claim 1, wherein the anionic monomer includes at least one anionic monomer from among 3-prop-2-enoyloxypropane-1-sulfonic acid, 3-(2-methylprop-2-enoyloxy)propane-1-sulfonic acid, and acrylic acid.

8. The anti-frost hydrogel coating composition of claim 1, wherein the ionic monomer includes the cationic monomer and the anionic monomer.

9. The anti-frost hydrogel coating composition of claim 1, wherein the two or more acrylic groups includes at least one acrylic group from among polyethylene glycol diacrylate, polyethylene glycol dimethacrylate, N,N′-methylenebisacrylamide, and trimethylolpropane triacrylate.

10. The anti-frost hydrogel coating composition of claim 1, wherein a concentration of the crosslinker ranges from 0.1 w/v % to 5.0 w/v %.

11. The anti-frost hydrogel coating composition of claim 1, wherein the polymerization initiator includes at least one polymerization initiator from among a thermal polymerization initiator and a photopolymerization initiator.

12. The anti-frost hydrogel coating composition of claim 1, further comprising a reaction catalyst for activating the polymerization initiator.

13. A method of forming an anti-frost hydrogel coating film on a substrate, the method comprising:
applying, on the substrate, an anti-frost hydrogel coating composition including an ionic monomer, a crosslinker including two or more acrylic groups, a polymerization initiator, and a solvent; and
crosslinking and polymerizing the anti-frost hydrogel coating composition to form the anti-frost hydrogel coating film including an ionic polymer on the substrate,
wherein the ionic monomer includes at least one ionic monomer from among a zwitterionic monomer, a cationic monomer, and an anionic monomer.

14. The method of claim 13, further comprising:
before the applying, surface-treating the substrate with a silane-based compound including an acrylic group to form an intermediate adhesive layer between the substrate and the anti-frost hydrogel coating film.

15. The method of claim 13, wherein the ionic monomer includes the cationic monomer and the anionic monomer at an equivalent ratio of 1:1.

16. A heat exchanger comprising:
at least one of a fin and a tube having a film of an anti-frost coating composition to reduce the freezing temperature on a surface of the at least one of the fin and the tube,
wherein the anti-frost coating composition includes:
an ionic monomer;
a crosslinker including two or more acrylic groups;
a polymerization initiator; and
a solvent,
the ionic monomer including at least one ionic monomer from among a zwitterionic monomer, a cationic monomer, and an anionic monomer.
